(19) United States
(12) Patent Application Publication
(10) Pub. No.: US 2021/0312214 A1
(43) Pub. Date: Oct. 7, 2021

(54) IMAGE RECOGNITION METHOD, APPARATUS AND NON-TRANSITORY COMPUTER READABLE STORAGE MEDIUM

(71) Applicant: SHENZHEN SENSETIME TECHNOLOGY CO., LTD., Shenzhen (CN)

(72) Inventors: Yuxin YANG, Shenzhen (CN); Wei Hui, Shenzhen (CN); Chengkai Zhu, Shenzhen (CN); Wei Wu, Shenzhen (CN); Jiangtao Li, Shenzhen (CN)

(21) Appl. No.: 17/353,045

(22) Filed: Jun. 21, 2021

Related U.S. Application Data
(63) Continuation of application No. PCT/CN2020/081371, filed on Mar. 26, 2020.

(30) Foreign Application Priority Data
Feb. 12, 2020 (CN) 202010089651.8

(51) Int. Cl. G06K 9/46; G06K 9/32; G06K 9/62; G06N 3/08

(52) U.S. Cl. CPC G06K 9/4671; G06K 9/4604; G06N 3/08; G06K 9/629; G06K 9/325

(57) ABSTRACT

The present disclosure relates to an image recognition method and apparatus, an electronic device and a storage medium. The method includes: performing a key point detection on an image to be processed to determine information of a plurality of contour key points of a target region in the image to be processed; correcting the target region in the image to be processed according to the information of the plurality of contour key points to obtain regional image information of a corrected region corresponding to the target region; and recognizing the regional image information to obtain a recognition result of the target region. By the embodiments of the present disclosure the accuracy of the target recognition can be improved.

The present application is a continuation of and claims priority under 35 U.S.C. 120 to PCT Application No. PCT/CN2020/081371, filed on Mar. 26, 2020, which claims priority to Chinese Patent Application No. 202010089651.8, filed with the Chinese National Intellectual Property Administration (CNIPA) on Feb. 12, 2020 and entitled “IMAGE RECOGNITION METHOD AND APPARATUS, ELECTRONIC DEVICE AND STORAGE MEDIUM”. All the above-referenced priority documents are incorporated herein by reference.

### TECHNICAL FIELD

The present disclosure relates to the technical field of computers, and particularly to an image recognition method, an apparatus and a non-transitory computer readable storage medium.

### BACKGROUND

In the fields of computer vision, intelligent video monitoring and the like, it is necessary to detect and recognize various objects (such as pedestrians, vehicles, etc.) in images.

### SUMMARY

The present disclosure provides an image recognition technical solution.

According to one aspect of the present disclosure, there is provided an image recognition method, comprising: performing a key point detection on an image to be processed to determine information of a plurality of contour key points of a target region in the image to be processed; correcting the target region in the image to be processed according to the information of the plurality of contour key points to obtain regional image information of a corrected region corresponding to the target region; and recognizing the regional image information to obtain a recognition result of the target region.

In a possible implementation, performing a key point detection on an image to be processed to determine information of a plurality of contour key points of a target region in the image to be processed includes: performing a feature extraction and fusion on the image to be processed to obtain a feature map of the image to be processed; and performing a key point detection on the feature map of the image to be processed to obtain the information of a plurality of contour key points of the target region in the image to be processed.

In a possible implementation, the information of the plurality of contour key points includes first positions of the plurality of contour key points; and correcting the target region in the image to be processed according to the information of the plurality of contour key points to obtain regional image information of a corrected region corresponding to the target region includes: determining a homography transformation matrix between the target region and the corrected region according to the first positions of the plurality of contour key points and second positions of the corrected region; and correcting an image or features of the target region according to the homography transformation matrix to obtain the regional image information of the corrected region.

In a possible implementation, determining a homography transformation matrix between the target region and the corrected region according to the first positions of the plurality of contour key points and second positions of the corrected region includes: normalizing respectively the first positions and the second positions to obtain normalized first positions and normalized second positions; and determining the homography transformation matrix between the target region and the corrected region according to the normalized first positions and the normalized second positions.

In a possible implementation, correcting the image of the target region according to the homography transformation matrix to obtain the regional image information of the corrected region includes: determining, according to third positions of a plurality of target points in the corrected region and the homography transformation matrix, pixel points in the target region which correspond to each of the third positions; mapping pixel information of the pixel points corresponding to each of the third positions to each of the target points; and performing interpolations among individual target points to obtain the regional image information of the corrected region.

In a possible implementation, recognizing the regional image information to obtain the recognition result of the target region includes: performing a feature extraction on the regional image information to obtain a feature vector of the regional image information; and decoding the feature vector to obtain the recognition result of the target region.

In a possible implementation, the method is implemented by a neural network; the neural network includes a target detection network, a correction network and a recognition network; the target detection network is configured to perform a key point detection on the image to be processed; the correction network is configured to correct the target region; and the recognition network is configured to recognize the regional image information, wherein the method further includes:
training the target detection network according to a preset training set to obtain a trained target detection network, the training set including a plurality of sample images, and contour key point denoting information, background denoting information and category denoting information of a target region in each of the sample images; and training the correction network and the recognition network according to the training set and the trained target detection network.

In a possible implementation, the target detection network includes a feature extraction sub-network, a feature fusion sub-network and a detection sub-network, and training the target detection network according to a preset training set to obtain a trained target detection network includes:
performing a feature extraction on the sample images by the feature extraction sub-network to obtain first features of the sample images; performing a feature fusion on the first features by the feature fusion sub-network to obtain a fused feature of the sample images; detecting the fused feature by the detection sub-network to obtain contour key point detection information and background detection information of a target in the sample images; and training the target detection network according to the contour key point detection information and background detection information for the plurality of sample images as well as the contour key point denoting information and the background denoting information for the plurality of sample images, to obtain the trained target detection network.

In a possible implementation, the target region includes a license plate region of a vehicle, and the recognition result of the target region includes a character category of the license plate region.

According to one aspect of the present disclosure, there is provided an image recognition apparatus, including: a key point detection module configured to perform a key point detection on an image to be processed to determine information of a plurality of contour key points of a target region in the image to be processed; a correction module configured to correct the target region in the image to be processed according to the information of the plurality of contour key points to obtain regional image information of a corrected region corresponding to the target region; and a recognition module configured to recognize the regional image information to obtain a recognition result of the target region.

In a possible implementation, the key point detection module includes: a feature extraction and fusion sub-module configured to perform a feature extraction and fusion on the image to be processed to obtain a feature map of the image to be processed; and a detection sub-module configured to perform a key point detection on the feature map of the image to be processed to obtain the information of the plurality of contour key points of the target region in the image to be processed.

In a possible implementation, the information of the plurality of contour key points includes first positions of the plurality of contour key points, the correction module includes: a transformation matrix determining sub-module configured to determine a homography transformation matrix between the target region and the corrected region according to the first positions of the plurality of contour key points and second positions of the corrected region; and a correction sub-module configured to correct an image or a feature of the target region according to the homography transformation matrix to obtain regional image information of the corrected region.

In a possible implementation, the transformation matrix determining sub-module is configured to: normalize respectively the first positions and the second positions to obtain normalized first positions and normalized second positions, and determine the homography transformation matrix between the target region and the corrected region according to the normalized first positions and the normalized second positions.

In a possible implementation, the correction sub-module is configured to: determine, according to third positions of a plurality of target points in the corrected region and the homography transformation matrix, pixel points in the target region which correspond to each of the third positions; map pixel information of the pixel points corresponding to each of the third positions to each of the target points; and perform interpolations among individual target points to obtain the regional image information of the corrected region.

In a possible implementation, the recognition module is configured to: perform a feature extraction on the regional image information to obtain a feature vector of the regional image information, and decode the feature vector to obtain the recognition result of the target region.

In a possible implementation, the apparatus is implemented by a neural network; the neural network includes a target detection network, a correction network and a recognition network; the target detection network is configured to perform a key point detection on the image to be processed; the correction network is configured to correct the target region; and the recognition network is configured to recognize the regional image information, wherein the apparatus further includes:
a first training module, configured to train the target detection network according to a preset training set to obtain a trained target detection network, the training set including a plurality of sample images, and contour key point denoting information, background denoting information and category denoting information of a target region in each of the sample images; and a second training module, configured to train the correction network and the recognition network according to the training set and the trained target detection network.

In a possible implementation, the target detection network includes a feature extraction sub-network, a feature fusion sub-network and a detection sub-network, and the first training module is further configured to: perform a feature extraction on the sample images by the feature extraction sub-network to obtain first features of the sample images; perform a feature fusion on the first features by the feature fusion sub-network to obtain a fused feature of the sample images; detect the fused feature by the detection sub-network to obtain contour key point detection information and background detection information of a target in the sample images; and train the target detection network according to the contour key point detection information and background detection information for the plurality of sample images as well as the contour key point denoting information and the background denoting information for the plurality of sample images, to obtain the trained target detection network.

In a possible implementation, the target region includes a license plate region of a vehicle, and the recognition result of the target region includes a character category of the license plate region.

According to one aspect of the present disclosure, there is provided an electronic device, including: a processor; and a memory, configured to store processor executable instructions, wherein the processor is configured to invoke the instructions stored in the memory to execute the above method.

According to one aspect of the present disclosure, there is provided a computer readable storage medium having computer program instructions stored thereon, wherein the computer program instructions, when executed by a processor, implement the above method.

According to one aspect of the present disclosure, there is provided a computer program, wherein the computer program includes computer readable codes, and when the computer readable codes run in an electronic device, a processor in the electronic device executes the above method.

According to embodiments of the present disclosure, the information of a plurality of contour key points of the target region in the image to be processed can be determined; the target region is corrected according to the information of the plurality of contour key points; and the regional image information from the correction is recognized to obtain a recognition result of the target region, thereby improving the accuracy of target recognition.

It should be understood that the above general descriptions and the following detailed descriptions are only exemplary and illustrative, and do not limit the present disclosure. Other features and aspects of the present disclosure will become apparent from the following detailed descriptions of exemplary embodiments with reference to the accompanying drawings.

### BRIEF DESCRIPTION OF THE DRAWINGS

The drawings described here are incorporated into the specification and constitute a part of the specification. The drawings illustrate embodiments in conformity with the present disclosure and are used to explain the technical solutions of the present disclosure together with the specification.

FIG. 1 illustrates a flow chart of an image recognition method according to an embodiment of the present disclosure.

FIG. 2 illustrates a schematic diagram of a key point detection process according to an embodiment of the present disclosure.

FIG. 3 illustrates a schematic diagram of an image recognition process according to an embodiment of the present disclosure.

FIG. 4 illustrates a block diagram of an image recognition apparatus according to an embodiment of the present disclosure.

FIG. 5 illustrates a block diagram of an electronic device according to an embodiment of the present disclosure.

FIG. 6 illustrates a block diagram of an electronic device according to an embodiment of the present disclosure.

### DETAILED DESCRIPTION

Various exemplary embodiments, features and aspects of the present disclosure are described in detail below with reference to the accompanying drawings. Same reference numerals in the drawings refer to elements with same or similar functions. Although various aspects of the embodiments are illustrated in the drawings, the drawings are unnecessary to draw to scale unless otherwise specified.

The term “exemplary” herein means “using as an example or an embodiment or being illustrative”. Any embodiment described herein as “exemplary” should not be construed as being superior or better than other embodiments.

Terms “and/or” used herein is only an association relationship describing the associated objects, which means that there may be three relationships; for example A and/or B may refer to the following three situations: A exists alone, both A and B exist, and B exists alone. Furthermore, the item “at least one of” herein means “any one of” a plurality of or “any combinations of” at least two of a plurality or; for example, “including at least one of A, B and C” may represent including any one or more elements selected from a set consisting of A, B and C.

Furthermore, for better describing the present disclosure, numerous specific details are illustrated in the following detailed description. Those skilled in the art should understand that the present disclosure may be implemented without certain specific details. In some examples, methods, means, elements and circuits that are well known to those skilled in the art are not described in detail in order to highlight the main idea of the present disclosure.

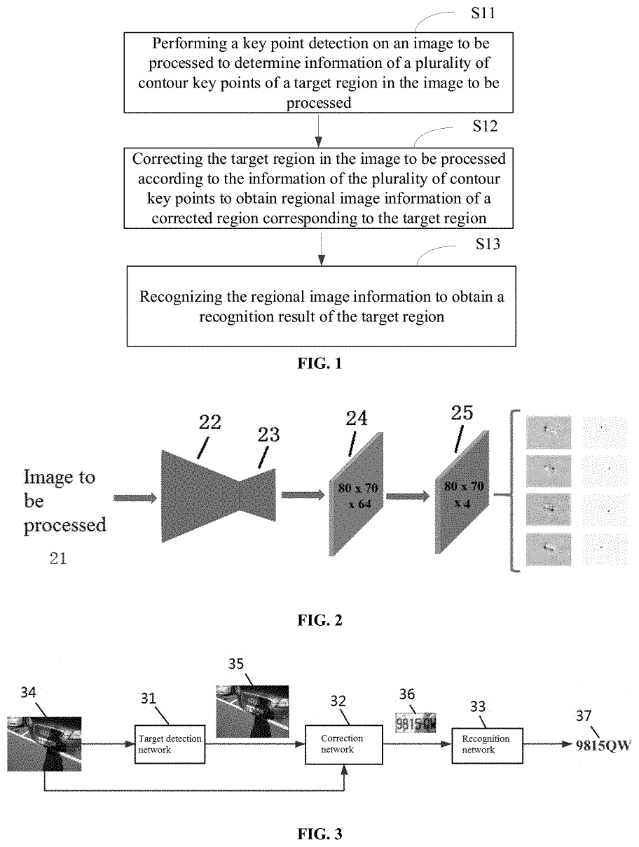

FIG. 1 illustrates a flow chart of an image recognition method according to an embodiment of the present disclosure. As shown in FIG. 1, the method includes:

In step S11, a key point detection is performed on an image to be processed to determine information of a plurality of contour key points of a target region in the image to be processed.

In step S12, the target region in the image to be processed is corrected according to the information of the plurality of contour key points to obtain regional image information of a corrected region corresponding to the target region.

In step S13, the regional image information is recognized to obtain a recognition result of the target region.

In a possible implementation, the image recognition method may be executed by an electronic device such as a terminal device or a server. The terminal device may be a user equipment (UE), a mobile device, a user terminal, a terminal, a cellular phone, a cordless telephone, a personal digital assistant (PDA), a handheld device, a computing device, a vehicle-mounted device, a wearable device, etc. The method may be implemented by a processor invoking computer readable instructions stored in a memory. Or, the method may be executed by the server.

For example, the image to be processed may be an image or a video frame acquired by an image acquisition device (such as a camera). The image to be processed includes a target to be recognized, such as a pedestrian, a vehicle, a license plate, etc.

In a possible implementation, the key point detection may be performed on the image to be processed in the step S11 to determine the information of a plurality of contour key points on a contour of an image region (may be referred to as a target region) in which the target is located in the image to be processed. Under the situation that the target region is a quadrilateral region, the plurality of contour key points of the target region may be, for example, four vertexes of the target region. It should be understood that the number of the detected contour key points may be set by those skilled in the art according to the actual situation, as long as the detected contour key points can define a range of the target region. The present disclosure does not limit a specific shape of the target region and the number of the contour key points.

In a possible implementation, because of a shooting angle of the image to be processed, the target region in the image to be processed may be distorted, rotated, deformed and the like. In this case, the target region in the image to be processed may be corrected by, for example, a homography transformation, according to the information of the plurality of contour key points in the step S12, to obtain the regional image information of the corrected region corresponding to the target region. The corrected region is a region displayed in a front view of the target region; for example, when the target is a license plate, the corrected region is a rectangular region where the license plate is located in the front view of the license plate. The regional image information of the corrected region may be an image or a feature map of the corrected region.

In a possible implementation, after the regional image information is obtained, the regional image information may be recognized in the step S13 to obtain a recognition result of the target region. The feature extraction may be performed on the regional image information, for example, through a neural network, and the extracted features are decoded to obtain the recognition result.

In a possible implementation, the target region includes a license plate region of a vehicle. The recognition result of the target region includes a character category of the license plate region. That is, when the target to be recognized is the license plate of the vehicle, a plurality of contour key points (such as four vertexes) of the license plate region in the image may be detected, and the license plate region is further corrected and recognized to obtain the character category of the license plate region, for example, the license plate region includes characters “9815 QW”.

In a possible implementation, when the target to be recognized is a billboard or shop sign, the obtained recognition result of the target region is the text and/or numbers on the billboard or shop sign. When the target to be recognized is a traffic sign, the obtained recognition result of the target region is a sign type of the traffic sign. The present disclosure makes no limitation thereto.

According to an embodiment of the present disclosure, the information of a plurality of contour key points of the target region in the image to be processed may be determined. The target region is corrected according to the information of the plurality of contour key points, and the regional image information from the correction is recognized to obtain a recognition result of the target region, thereby improving the accuracy of target recognition.

In a possible implementation, the step S11 may include:

A feature extraction and fusion is performed on the image to be processed to obtain a feature map of the image to be processed.

A key point detection is performed on the feature map of the image to be processed to obtain the information of the plurality of contour key points of the target region in the image to be processed.

For example, the key point detection may be performed on the image to be processed through the target detection network. The target detection network may be, for example, a convolutional neural network. The target detection network may include a feature extraction sub-network, a feature fusion sub-network and a detection sub-network.

In a possible implementation, the feature extraction may be performed on the image to be processed through the feature extraction sub-network to obtain features of multiple scales of the image to be processed. The feature extraction sub-network may adopt a residual network (Resnet) including a plurality of residual layers or residual blocks. It should be understood that the feature extraction sub-network may also adopt network structures of a googlenet, a vggnet, a shufflenet, a darknet and the like, which is not limited by the present disclosure.

In a possible implementation, the features of multiple scales of the image to be processed may be fused by the feature fusion sub-network to obtain a feature of one scale, i.e., the feature map of the image to be processed. The feature fusion sub-network may adopt a Feature Pyramid Network (FPN), and may also adopt network structures of a Neural Architecture Search FPN (NAS-FPN), a hourglass and the like, which is not limited by the present disclosure.

In a possible implementation, the key point detection may be performed on the feature map of the image to be processed through the detection sub-network to obtain the information of a plurality of contour key points of the target region in the image to be processed. The detection sub-network may include a plurality of convolutional layers and a plurality of detection layers (for example, including a full connection layer). Feature information in the feature map of the image to be processed is further extracted through the plurality of convolutional layers, and then positions of the key points in the feature information are detected respectively through the plurality of detection layers. In a case where the target region is quadrilateral, four positioning thermodynamic maps may be predicted, which position respectively the positions of a top left vertex, a top right vertex, a bottom right vertex and a bottom left vertex (i.e., four key points) of the target region. Each thermodynamic map may be defined as that the position of a vertex coordinate is 1 and the rest are 0. A 01 coding of 01 may be selected, which may also be replaced by a Gaussian coding. The present disclosure makes no limitation thereto.

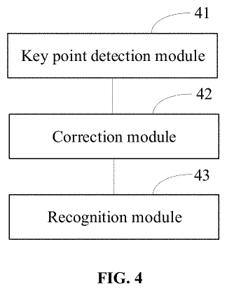

FIG. 2 illustrates a schematic diagram of a key point detection process according to an embodiment of the present disclosure. As shown in FIG. 2, an image to be processed 21 is input to a target detection network, and feature extraction and fusion is performed through a residual network (Res) 22 and a feature pyramid network (FPN) 23 sequentially, to obtain a feature map 24. A dimension of the image to be processed 21 may be, for example, 320×280, and after the feature extraction and fusion, the feature map 24 with a dimension of 80×70×64 is obtained. Convolution and key point detection are performed further on the feature map 24 through the detection sub-network (not shown) to obtain positioning thermodynamic maps of 80×70×4 for the four key points, thereby determining the positions of the top left vertex, the top right vertex, the bottom right vertex and the bottom left vertex of the target region.

In this way, the information of a plurality of contour key points of the target region may be determined rapidly, thereby accurately defining a border contour of the target region, and improving a processing speed and accuracy.

In a possible implementation, the information of the plurality of contour key points includes first positions of the plurality of contour key points. The step S12 may include:
determining a homography transformation matrix between the target region and the corrected region according to the first positions of the plurality of contour key points and the second positions of the corrected region; and
correcting an image or features of the target region according to the homography transformation matrix to obtain the regional image information of the corrected region.

For example, after the information of a plurality of contour key points of the target region is determined, the target region may be corrected. The information of the plurality of contour key points may include the position coordinates of each contour key point in the image to be processed or in the feature map of the image to be processed (i.e. the first positions of each contour key point). When the target region is a quadrilateral region, the target region may include four contour key points.

In a possible implementation, the dimension of the image to be processed or the feature map thereof may be set as h (height)×w (width)×C (number of channels). The coordinates of the contour key points are (x1, y1, x2, y2, x3, y3, x4, y4), and the corrected region after correction is of hx (height)×w×(width)×C (number of channels). The position of the target region may be determined according to the first positions of a plurality of contour key points, and the homography transformation matrix between the target region and the corrected region may be determined according to the position of the target region and the second positions of the corrected region. It should be understood that the homography transformation matrix between the target region and the corrected region may be determined in a way known in the prior art, which is not limited by the present disclosure.

In a possible implementation, the step of determining a homography transformation matrix between the target region and the corrected region according to the first positions of the plurality of contour key points and the second positions of the corrected region may include:
normalizing respectively the first positions and the second positions to obtain normalized first positions and normalized second positions; and
determining the homography transformation matrix between the target region and the corrected region according to the normalized first positions and the normalized second positions.

That is, the input coordinates (x1, y1, x2, y2, x3, y3, x4, y4) of contour key points and the output coordinates of the corrected region h_{H} (height)×w_{H} (width)×C (number of channels) can be normalized respectively. The input coordinates and the output coordinates are normalized into a range of [−1, 1] to obtain the normalized first positions and the normalized second positions. The homography transformation matrix between the target region and the corrected region is determined according to the normalized first positions and the normalized second positions (for example, a matrix of 3×3 is obtained). The way of determining the homography transformation matrix is not limited by the present disclosure.

In this way, the scale of the target region and the scale of the corrected region may be unified, reducing errors caused by the difference in the scales of the target region and the corrected region, and improving the accuracy of the homography transformation matrix.

In a possible implementation, the step of correcting the image or features of the target region according to the homography transformation matrix to obtain regional image information of the corrected region may include:
according to third positions of a plurality of target points in the corrected region and the homography transformation matrix, determining pixel points in the target region which correspond to each of the third positions; and
mapping pixel information of the pixel points corresponding to each of the third positions to each of the target points; and performing interpolations among individual target points to obtain the regional image information of the corrected region.

For example, for the normalized second positions of the corrected region, w_{H} and h_{H} points are equidistantly collected between [−1, 1] on an X axis and Y axis of the coordinates to obtain rasterized coordinates of the corrected region (a total of h_{H}×w_{H} coordinates). The rasterized coordinates are used as a plurality of target points in the corrected region. Positions of the corresponding pixels in the target region may be calculated according to the third positions of a plurality of target points and the homography transformation matrix, thereby determining the pixels corresponding to each of the third positions in the target region.

In a possible implementation, the pixel information (i.e. the pixel value) of the pixel corresponding to each of the third positions may be mapped to each target point, and interpolation is performed among individual target points to obtain the regional image information of the corrected region. A bilinear interpolation way may be used, or other interpolation ways may be used, which is not limited by the present disclosure. The regional image information may be a regional image or a regional feature map, which is not limited by the present disclosure.

In this way, the tilted and rotated target region may be corrected to a horizontal direction. The processing may be referred to as a homopooling operation, which may be differentiated and inversely propagated for correcting the image or features of the target region and may be embedded into any neural network for end-to-end training, so that an entire image recognition process may be realized in a unified network.

In a possible implementation, the step S13 includes:
performing a feature extraction on the regional image information to obtain a feature vector of the regional image information; and decoding the feature vector to obtain the recognition result of the target region.

For example, the regional image information may be recognized by a recognition network. The recognition network may include a plurality of convolutional layers, a group normalization layers, a RELU activation layer, a maximal pooling layer and other network layers. The features of the regional image information are extracted by the individual network layers. The feature vector with a width of 1 may be obtained, such as a feature vector with a dimension of 1×47.

In a possible implementation, the recognition network may further include a full connection layer and a CTC (Connectionist Temporal Classification) decoder. A character probability distribution vector for the regional image information may be obtained by processing the feature vector through the full connection layer. The character probability distribution vector is decoded by the CTC decoder to obtain the recognition result of the target region. When the target is a license plate, the recognition result of the target region is characters corresponding to the license plate, for example, characters 9815QW. In this way, the accuracy of the recognition result may be improved.

FIG. 3 illustrates a schematic diagram of an image recognition process according to an embodiment of the present disclosure. As shown in FIG. 3, the image recognition method according to the embodiment of the present disclosure may be implemented by a neural network. The neural network includes a target detection network 31, a correction network 32 and a recognition network 33. The target detection network 31 is configured to perform the key point detection on the image to be processed. The correction network 32 is configured to correct the target region. The recognition network 33 is configured to recognize the regional image information.

As shown in FIG. 3, a target in an image to be processed 34 is a license plate of a vehicle, and the image to be processed 34 may be input to the target detection network 31 for key point detection to obtain an image 35 including four vertexes of the license plate. Through the correction network 32, the license plate region of the image to be processed 34 is corrected with the four vertexes in the image 35, to obtain a license plate image 36. The license plate image 36 is input to the recognition network 33 for recognition to obtain a recognition result 37 of the license plate region, i.e., characters 9815QW corresponding to the license plate.

Prior to deployment of the neural network, the neural network needs to be trained. The image recognition method according to the embodiment of the present disclosure further includes:
training the target detection network according to a preset training set to obtain a trained target detection network, the training set including a plurality of sample images, and contour key point denoting information, background denoting information and category denoting information of a target region in each of the sample images; and
training the correction network and the recognition network according to the training set and the trained target detection network.

For example, the neural network may be trained at two stages, that is, the target detection network is trained first, and then the correction network and the recognition network are trained.

At the first stage of the training, the sample images in the training set may be input to the target detection network, and contour key point detection information of the target region in the sample images is output. Parameters of the target detection network are adjusted according to differences between the contour key point detection information and the contour key point denoting information for a plurality of sample images, until a preset training condition is satisfied, thereby obtaining the trained target detection network.

At the second stage of the training, the sample image in the training set may be input to the trained target detection network, so as to be processed by the trained target detection network, the correction network and the recognition network, thereby obtaining a training recognition result of the target region in the sample image. The parameters of the correction network and the recognition network are adjusted according to differences between the training recognition results and the category denoting information for a plurality of sample images, until the preset training condition is satisfied, thereby obtaining the trained correction network and recognition network.

In this way, the training effect can be improved, and the training speed can be increased.

In a possible implementation, the step of training the target detection network according to the preset training set to obtain the trained target detection network includes:
performing a feature extraction on the sample images by the feature extraction sub-network to obtain first features of the sample images;
performing a feature fusion on the first features by the feature fusion sub-network to obtain a fused feature of the sample images;
detecting the fused feature by the detection sub-network to obtain contour key point detection information and background detection information of a target in the sample images; and
training the target detection network according to the contour key point detection information and background detection information for the plurality of sample images as well as the contour key point denoting information and the background denoting information for the plurality of sample images, to obtain the trained target detection network.

For example, detection on background may be added during the training, thereby improving the training effect. The sample images may be input to the feature extraction sub-network for feature extraction to obtain the first features of the sample images. The first features are input to the feature fusion sub-network for feature fusion to obtain the fused feature of the sample images; and the fused feature is input to the detection sub-network for detection to obtain the contour key point detection information and background detection information of the target in the sample images. That is, when the target is the license plate, the detection information of four vertexes and the detection information of the background in the sample images may be obtained.

In a possible implementation, a network loss of the target detection network may be determined according to the contour key point detection information and background detection information for the plurality of sample images as well as the contour key point denoting information and the background denoting information for the plurality of sample images; the parameters of the target detection network then are adjusted according to the network loss until a preset training condition is satisfied, and the trained target detection network is obtained.

The background detection is added as a supervisory signal, so that the training effect on the target detection network can be improved greatly.

By the image recognition method according to the embodiment of the present disclosure, targets with an uncertain character length at multiple angles in the image (such as license plates, billboards, traffic signs and the like) can be recognized accurately. Instead of bounding box-based license plate detection, the method uses key point recognition, which does not require pixel-to-pixel regression or detection anchors, thereby eliminating the non-maximum-value suppression, and increasing the detection speed greatly. The thermodynamic map of the key point is used as a goal of regression, improving the accuracy of positioning. At the same time, by increasing the number of points, more information of the license plate may be acquired for correcting the license plate with homopooling.

The image recognition method according to the embodiment of the present invention can use homopooling to correct an image or features of the license plate, and may be embedded into any network, thereby realizing a unified network for end-to-end joint training. Individual parts of the network may be jointly optimized to guarantee the speed and the accuracy.

The image recognition method according to the embodiment of the present disclosure may be used in scenarios such as smart cities, intelligent transportation, security monitoring, parking lots, vehicle re-recognition, recognition of vehicles with fake plates, and the likes, where plate numbers can be recognized rapidly and accurately, and further utilized collect tolls, impose fines, detect the vehicles with fake plates, etc.

It can be understood that the above method embodiments described in the present disclosure may be combined with each other to form combined embodiments without departing from principles and logics, which are not repeated in the present disclosure due to space limitation. It will be appreciated by those skilled in the art that a specific execution sequence of various steps in the above methods in specific implementations are determined on the basis of their functions and possible intrinsic logics.

Furthermore, the present disclosure further provides an image recognition apparatus, an electronic device, a computer-readable storage medium and a program, all of which may be used to implement any image recognition method provided by the present disclosure. For the corresponding technical solutions and descriptions, please refer to the corresponding records in the method part, which will not be repeated herein.

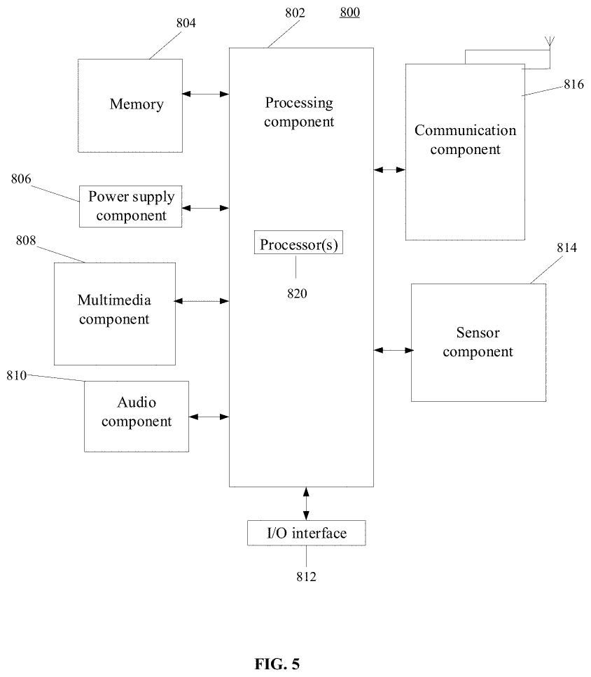

FIG. 4 illustrates a block diagram of an image recognition apparatus according to an embodiment of the present disclosure. As shown in FIG. 4, the apparatus includes:
a key point detection module 41 configured to perform a key point detection on an image to be processed to determine information of a plurality of contour key points of a target region in the image to be processed; a correction module 42 configured to correct the target region in the image to be processed according to the information of the plurality of contour key points to obtain regional image information of a corrected region corresponding to the target region; and a recognition module 43 configured to recognize the regional image information to obtain a recognition result of the target region.

In a possible implementation, the key point detection module includes: a feature extraction and fusion sub-module configured to perform a feature extraction and fusion on the image to be processed to obtain a feature map of the image to be processed; and a detection sub-module configured to perform a key point detection on the feature map of the image to be processed to obtain the information of the plurality of contour key points of the target region in the image to be processed.

In a possible implementation, the information of the plurality of contour key points includes first positions of the plurality of contour key points. The correction module includes: a transformation matrix determining sub-module configured to determine a homography transformation matrix between the target region and the corrected region according to the first positions of the plurality of contour key points and second positions of the corrected region; and a correction sub-module configured to correct an image or a feature of the target region according to the homography transformation matrix to obtain regional image information of the corrected region.

In a possible implementation, the transformation matrix determining sub-module is configured to: normalize respectively the first positions and the second positions to obtain normalized first positions and normalized second positions, and determine the homography transformation matrix between the target region and the corrected region according to the normalized first positions and the normalized second positions.

In a possible implementation, the correction sub-module is configured to: determine, according to third positions of a plurality of target points in the corrected region and the homography transformation matrix, pixel points in the target region which correspond to each of the third positions; map pixel information of the pixel points corresponding to each of the third positions to each of the target points; and perform interpolations among individual target points to obtain the regional image information of the corrected region.

In a possible implementation, the recognition module is configured to: perform a feature extraction on the regional image information to obtain a feature vector of the regional image information, and decode the feature vector to obtain the recognition result of the target region.

In a possible implementation, the apparatus is implemented by a neural network; the neural network includes a target detection network, a correction network and a recognition network; the target detection network is configured to perform a key point detection on the image to be processed; the correction network is configured to correct the target region; and the recognition network is configured to recognize the regional image information, wherein the apparatus further includes:
a first training module, configured to train the target detection network according to a preset training set to obtain a trained target detection network, the training set including a plurality of sample images, and contour key point denoting information, background denoting information and category denoting information of a target region in each of the sample images; and a second training module, configured to train the correction network and the recognition network according to the training set and the trained target detection network.

In a possible implementation, the target detection network includes a feature extraction sub-network, a feature fusion sub-network and a detection sub-network, and the first training module is configured to: perform a feature extraction on the sample images by the feature extraction sub-network to obtain first features of the sample images; perform a feature fusion on the first features by the feature fusion sub-network to obtain a fused feature of the sample images; detect the fused feature by the detection sub-network to obtain contour key point detection information and background detection information of a target in the sample images; and train the target detection network according to the contour key point detection information and background detection information for the plurality of sample images as well as the contour key point denoting information and the background denoting information for the plurality of sample images, to obtain the trained target detection network.

In a possible implementation, the target region includes a license plate region of a vehicle, and the recognition result of the target region includes a character category of the license plate region.

In some embodiments, functions or modules of the apparatus provided in the embodiments of the present disclosure may be used to execute the method described in the above method embodiments, which may be specifically implemented by referring to the above descriptions of the method embodiments, and are not repeated here for brevity.

An embodiment of the present disclosure further provides a computer readable storage medium having computer program instructions stored thereon, wherein the computer program instructions, when executed by a processor, implement the above method. The computer readable storage medium may be a non-volatile computer readable storage medium or volatile computer readable storage medium.

An embodiment of the present disclosure further provides an electronic device, which includes a processor and a memory configured to store processor executable instructions, wherein the processor is configured to invoke the instructions stored in the memory to execute the above method.

An embodiment of the present disclosure further provides a computer program product, which includes computer readable codes. When the computer readable codes run in the device, the processor in the device executes instructions for implementing the image recognition method as provided in any of the above embodiments.

An embodiment of the present disclosure further provides another computer program product storing computer readable instructions. The instructions, when executed, cause the computer to perform operations of the image recognition method provided in any one of the above embodiments.

The electronic device may be provided as a terminal, a server or a device in any other form.

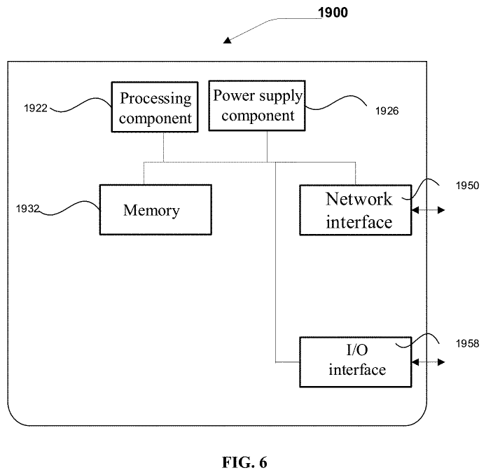

FIG. 5 illustrates a block diagram of an electronic device 800 according to an embodiment of the present disclosure. For example, the electronic device 800 may be a mobile phone, a computer, a digital broadcast terminal, a message transceiver, a game console, a tablet device, medical equipment, fitness equipment, a personal digital assistant or any other terminal.

Referring to FIG. 5, the electronic device 800 may include one or more of the following components: a processing component 802, a memory 804, a power supply component 806, a multimedia component 808, an audio component 810, an input/output (I/O) interface 812, a sensor component 814 and a communication component 816.

The processing component 802 generally controls the overall operation of the electronic device 800, such as operations related to display, phone call, data communication, camera operation and record operation. The processing component 802 may include one or more processors 820 to execute instructions so as to complete all or some steps of the above method. Furthermore, the processing component 802 may include one or more modules for interaction between the processing component 802 and other components. For example, the processing component 802 may include a multimedia module to facilitate the interaction between the multimedia component 808 and the processing component 802.

The memory 804 is configured to store various types of data to support the operations of the electronic device 800. Examples of these data include instructions for any application or method operated on the electronic device 800, contact data, telephone directory data, messages, pictures, videos, etc. The memory 804 may be any type of volatile or non-volatile storage devices or a combination thereof, such as static random access memory (SRAM), electronic erasable programmable read-only memory (EEPROM), erasable programmable read-only memory (EPROM), programmable read-only memory (PROM), read-only memory (ROM), a magnetic memory, a flash memory, a magnetic disk or a compact disk.

The power supply component 806 supplies electric power to various components of the electronic device 800. The power supply component 806 may include a power supply management system, one or more power supplies, and other components related to power generation, management and allocation of the electronic device 800.

The multimedia component 808 includes a screen providing an output interface between the electronic device 800 and a user. In some embodiments, the screen may include a liquid crystal display (LCD) and a touch panel (TP). If the screen includes the touch panel, the screen may be implemented as a touch screen to receive an input signal from the user. The touch panel includes one or more touch sensors to sense the touch, sliding, and gestures on the touch panel. The touch sensor may not only sense a boundary of the touch or sliding action, but also detect the duration and pressure related to the touch or sliding operation. In some embodiments, the multimedia component 808 includes a front camera and/or a rear camera. When the electronic device 800 is in an operating mode such as a shooting mode or a video mode, the front camera and/or the rear camera may receive external multimedia data. Each front camera and rear camera may be a fixed optical lens system or have a focal length and optical zooming capability.

The audio component 810 is configured to output and/or input an audio signal. For example, the audio component 810 includes a microphone (MIC). When the electronic device 800 is in an operating mode such as a call mode, a record mode and a voice identification mode, the microphone is configured to receive the external audio signal. The received audio signal may be further stored in the memory 804 or sent by the communication component 816. In some embodiments, the audio component 810 also includes a loudspeaker which is configured to output the audio signal.

The I/O interface 812 provides an interface between the processing component 802 and a peripheral interface module. The peripheral interface module may be a keyboard, a click wheel, buttons, etc. These buttons may include but are not limited to home buttons, volume buttons, start buttons and lock buttons.

The sensor component 814 includes one or more sensors which are configured to provide state evaluation in various aspects for the electronic device 800. For example, the sensor component 814 may detect an on/off state of the electronic device 800 and relative locations of the components such as a display and a small keyboard of the electronic device 800. The sensor component 814 may also detect the position change of the electronic device 800 or an component of the electronic device 800, presence or absence of a user contact with electronic device 800, directions or acceleration/deceleration of the electronic device 800 and the temperature change of the electronic device 800. The sensor component 814 may include a proximity sensor configured to detect the presence of nearby objects without any physical contact. The sensor component 814 may further include an optical sensor such as a CMOS or CCD image sensor which is used in an imaging application. In some embodiments, the sensor component 814 may further include an acceleration sensor, a gyroscope sensor, a magnetic sensor, a pressure sensor or a temperature sensor.

The communication component 816 is configured to facilitate the communication in a wire or wireless manner between the electronic device 800 and other devices. The electronic device 800 may access a wireless network based on communication standards, such as WiFi, 2G or 3G, or a combination thereof. In an exemplary embodiment, the communication component 816 receives a broadcast signal or broadcast related information from an external broadcast management system via a broadcast channel. In an exemplary embodiment, the communication component 816 further includes a near field communication (NFC) module to promote the short range communication. For example, the NFC module may be implemented on the basis of radio frequency identification (RFID) technology, infrared data association (IrDA) technology, ultra-wide band (UWB) technology, Bluetooth (BT) technology and other technologies.

In exemplary embodiments, the electronic device 800 may be implemented by one or more application dedicated integrated circuits (ASIC), digital signal processors (DSP), digital signal processing device (DSPD), programmable logic device (PLD), field programmable gate array (FPGA), controllers, microcontrollers, microprocessors or other electronic elements and is used to execute the above method.

In an exemplary embodiment, there is further provided a non-volatile computer readable storage medium, such as a memory 804 including computer program instructions. The computer program instructions may be executed by a processor 820 of an electronic device 800 to implement the above method.

FIG. 6 illustrates a block diagram of an electronic device 1900 according to an embodiment of the present disclosure. According to FIG. 6, the electronic device 1900 includes a processing component 1922, which further includes one or more processors and memory resources represented by a memory 1932 and configured to store instructions executed by the processing component 1922, such as an application program. The application program stored in the memory 1932 may include one or more modules each corresponding to a group of instructions. Furthermore, the processing component 1922 is configured to execute the instructions so as to execute the above method.

The electronic device 1900 may further include a power supply component 1926 configured to perform power supply management on the electronic device 1900, a wire or wireless network interface 1950 configured to connect the electronic device 1900 to a network, and an input/output (I/O) interface 1958. The electronic device 1900 may run an operating system stored in the memory 1932, such as Windows Server™, Mac OS X™, Unix™, Linux™, FreeBSD™ or the like.

In an exemplary embodiment, there is further provided a non-volatile computer readable storage medium, such as a memory 1932 including computer program instructions. The computer program instructions may be executed by a processing module 1922 of an electronic device 1900 to execute the above method.

The present disclosure may be implemented by a system, a method, and/or a computer program product. The computer program product may include a computer readable storage medium having computer readable program instructions for causing a processor to carry out the aspects of the present disclosure stored thereon.

The computer readable storage medium may be a tangible device that may retain and store instructions used by an instruction executing device. The computer readable storage medium may be, but not limited to, e.g., electronic storage device, magnetic storage device, optical storage device, electromagnetic storage device, semiconductor storage device, or any proper combination thereof. A non-exhaustive list of more specific examples (a non-exhaustive list) of the computer readable storage medium includes: portable computer diskette, hard disk, random access memory (RAM), read-only memory (ROM), erasable programmable read-only memory (EPROM or Flash memory), static random access memory (SRAM), portable compact disc read-only memory (CD-ROM), digital versatile disk (DVD), memory stick, floppy disk, mechanically encoded device (for example, punch-cards or raised structures in a groove having instructions recorded thereon), and any proper combination thereof. A computer readable storage medium referred herein should not to be construed as transitory signal per se, such as radio waves or other freely propagating electromagnetic waves, electromagnetic waves propagating through a waveguide or other transmission media (e.g., light pulses passing through a fiber-optic cable), or electrical signal transmitted through a wire.

Computer readable program instructions described herein may be downloaded to individual computing/processing devices from a computer readable storage medium or to an external computer or external storage device via network, for example, the Internet, local region network, wide region network and/or wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium in the respective computing/processing devices.

Computer readable program instructions for carrying out the operations of the present disclosure may be assembler instructions, instruction-set-architecture (ISA) instructions, machine instructions, machine-related instructions, microcode, firmware instructions, state-setting data, or source code or object code written in any combination of one or more programming languages, including an object oriented programming language, such as Smalltalk, C++ or the like, and the conventional procedural programming languages, such as the “C” programming language or similar programming languages. The computer readable program instructions may be executed completely on the user's computer, partly on the user's computer, as a stand-alone software package, partly on the user's computer and partly on a remote computer, or completely on a remote computer or a server. In the scenario with remote computer, the remote computer may be connected to the user's computer through any type of network, including local region network (LAN) or wide region network (WAN), or connected to an external computer (for example, through the Internet connection from an Internet Service Provider). In some embodiments, electronic circuitry, such as programmable logic circuitry, field-programmable gate arrays (FPGA), or programmable logic arrays (PLA), may be customized from state information of the computer readable program instructions; and the electronic circuitry may execute the computer readable program instructions, so as to achieve the aspects of the present disclosure.

Aspects of the present disclosure have been described herein with reference to the flowchart and/or the block diagrams of the method, device (systems), and computer program product according to the embodiments of the present disclosure. It will be appreciated that each block in the flowchart and/or the block diagram, and combinations of blocks in the flowchart and/or block diagram, may be implemented by the computer readable program instructions.

These computer readable program instructions may be provided to a processor of a general purpose computer, a dedicated computer, or other programmable data processing devices, to produce a machine, such that the instructions create means for implementing the functions/acts specified in one or more blocks in the flowchart and/or block diagram when executed by the processor of the computer or other programmable data processing devices. These computer readable program instructions may also be stored in a computer readable storage medium, wherein the instructions cause a computer, a programmable data processing device and/or other devices to function in a particular manner, such that the computer readable storage medium having instructions stored therein includes a product that includes instructions implementing aspects of the functions/acts specified in one or more blocks in the flowchart and/or block diagram.

The computer readable program instructions may also be loaded onto a computer, other programmable data processing devices, or other devices to have a series of operational steps performed on the computer, other programmable devices or other devices, so as to produce a computer implemented process, such that the instructions executed on the computer, other programmable devices or other devices implement the functions/acts specified in one or more blocks in the flowchart and/or block diagram.

The flowcharts and block diagrams in the drawings illustrate the architecture, function, and operation that may be implemented by the system, method and computer program product according to the various embodiments of the present disclosure. In this regard, each block in the flowchart or block diagram may represent a part of a module, a program segment, or a portion of code, which includes one or more executable instructions for implementing the specified logical function(s). In some alternative implementations, the functions denoted in the blocks may occur in an order different from that denoted in the drawings. For example, two contiguous blocks may, in fact, be executed substantially concurrently, or sometimes they may be executed in a reverse order, depending upon the functions involved. It will also be noted that each block in the block diagram and/or flowchart, and combinations of blocks in the block diagram and/or flowchart, may be implemented by dedicated hardware-based systems performing the specified functions or acts, or by combinations of dedicated hardware and computer instructions.

The computer program product may be implemented specifically by hardware, software or a combination thereof. In an optional embodiment, the computer program product is specifically embodied as a computer storage medium. In another optional embodiment, the computer program product is specifically embodied as a software product, such as software development kit (SDK) and the like.

On the premise of not violating the logic, different embodiments of the present disclosure may be combined with one another. Different embodiments may describe different aspects. For the emphasized description, please refer to the records of other embodiments.

Although the embodiments of the present disclosure have been described above, it will be appreciated that the above descriptions are merely exemplary, but not exhaustive; and that the disclosed embodiments are not limiting. A number of variations and modifications may occur to one skilled in the art without departing from the scopes and spirits of the described embodiments. The terms in the present disclosure are selected to provide the best explanation on the principles and practical applications of the embodiments and the technical improvements to the arts on market, or to make the embodiments described herein understandable to one skilled in the art.

What is claimed is:

1. An image recognition method, comprising:
performing a key point detection on an image to be processed to determine information of a plurality of contour key points of a target region in the image to be processed;
correcting the target region in the image to be processed according to the information of the plurality of contour key points to obtain regional image information of a corrected region corresponding to the target region; and
recognizing the regional image information to obtain a recognition result of the target region.

2. The method according to claim 1, wherein performing a key point detection on an image to be processed to determine information of a plurality of contour key points of a target region in the image to be processed includes:
performing a feature extraction and fusion on the image to be processed to obtain a feature map of the image to be processed; and
performing a key point detection on the feature map of the image to be processed to obtain the information of a plurality of contour key points of the target region in the image to be processed.

3. The method according to claim 1, wherein the information of the plurality of contour key points includes first positions of the plurality of contour key points; and correcting the target region in the image to be processed according to the information of the plurality of contour key points to obtain regional image information of a corrected region corresponding to the target region includes:
determining a homography transformation matrix between the target region and the corrected region according to the first positions of the plurality of contour key points and second positions of the corrected region; and
correcting an image or features of the target region according to the homography transformation matrix to obtain the regional image information of the corrected region.

4. The method according to claim 3, wherein determining a homography transformation matrix between the target region and the corrected region according to the first positions of the plurality of contour key points and second positions of the corrected region includes:
normalizing respectively the first positions and the second positions to obtain normalized first positions and normalized second positions; and
determining the homography transformation matrix between the target region and the corrected region according to the normalized first positions and the normalized second positions.

5. The method according to claim 3, wherein correcting an image of the target region according to the homography transformation matrix to obtain the regional image information of the corrected region includes:
determining, according to third positions of a plurality of target points in the corrected region and the homography transformation matrix, pixel points in the target region which correspond to each of the third positions;
mapping pixel information of the pixel points corresponding to each of the third positions to each of the target points; and performing interpolations among individual target points to obtain the regional image information of the corrected region.

6. The method according to claim 1, wherein recognizing the regional image information to obtain the recognition result of the target region includes:
performing a feature extraction on the regional image information to obtain a feature vector of the regional image information; and
decoding the feature vector to obtain the recognition result of the target region.

7. The method according to claim 1, wherein the method is implemented by a neural network, the neural network comprises a target detection network, a correction network and a recognition network, the target detection network is configured to perform a key point detection on the image to be processed, the correction network is configured to correct the target region, and the recognition network is configured to recognize the regional image information,
wherein the method further comprises:
training the target detection network according to a preset training set to obtain a trained target detection network, the training set comprising a plurality of sample images, and contour key point denoting information, background denoting information and category denoting information of a target region in each of the sample images; and
training the correction network and the recognition network according to the training set and the trained target detection network.

8. The method according to claim 7, wherein the target detection network includes a feature extraction sub-network, a feature fusion sub-network and a detection sub-network, and
training the target detection network according to a preset training set to obtain a trained target detection network comprising:
performing a feature extraction on the sample images by the feature extraction sub-network to obtain first features of the sample images;
performing a feature fusion on the first features by the feature fusion sub-network to obtain a fused feature of the sample images;
detecting the fused feature by the detection sub-network to obtain contour key point detection information and background detection information of a target in the sample images; and
training the target detection network according to the contour key point detection information and background detection information for the plurality of sample images as well as the contour key point denoting information and the background denoting information for the plurality of sample images, to obtain the trained target detection network.

9. The method according to claim 1, wherein the target region includes a license plate region of a vehicle, and the recognition result of the target region includes a character category of the license plate region.

10. An imaging recognition apparatus, comprising:
a processor; and
a memory storing processor executable instructions;
wherein the processor is configured to invoke the processor executable instructions stored in the memory to:
perform a key point detection on an image to be processed to determine information of a plurality of contour key points of a target region in the image to be processed;
correct the target region in the image to be processed according to the information of the plurality of contour key points to obtain regional image information of a corrected region corresponding to the target region; and
recognize the regional image information to obtain a recognition result of the target region.

11. The apparatus according to claim 10, wherein performing a key point detection on an image to be processed to determine information of a plurality of contour key points of a target region in the image to be processed includes:
performing a feature extraction and fusion on the image to be processed to obtain a feature map of the image to be processed; and
performing a key point detection on the feature map of the image to be processed to obtain the information of a plurality of contour key points of the target region in the image to be processed.

12. The apparatus according to claim 10, wherein the information of the plurality of contour key points includes first positions of the plurality of contour key points; and correcting the target region in the image to be processed according to the information of the plurality of contour key points to obtain regional image information of a corrected region corresponding to the target region includes:
determining a homography transformation matrix between the target region and the corrected region according to the first positions of the plurality of contour key points and second positions of the corrected region; and
correcting an image or features of the target region according to the homography transformation matrix to obtain the regional image information of the corrected region.

13. The apparatus according to claim 12, wherein determining a homography transformation matrix between the target region and the corrected region according to the first positions of the plurality of contour key points and second positions of the corrected region includes:
normalizing respectively the first positions and the second positions to obtain normalized first positions and normalized second positions; and
determining the homography transformation matrix between the target region and the corrected region according to the normalized first positions and the normalized second positions.

14. The apparatus according to claim 12, wherein correcting an image of the target region according to the homography transformation matrix to obtain the regional image information of the corrected region includes:
determining, according to third positions of a plurality of target points in the corrected region and the homography transformation matrix, pixel points in the target region which correspond to each of the third positions;
mapping pixel information of the pixel points corresponding to each of the third positions to each of the target points; and performing interpolations among individual target points to obtain the regional image information of the corrected region.

15. The apparatus according to claim 10, wherein recognizing the regional image information to obtain the recognition result of the target region includes:
performing a feature extraction on the regional image information to obtain a feature vector of the regional image information; and
decoding the feature vector to obtain the recognition result of the target region.

16. The apparatus according to claim 10, wherein the apparatus is implemented by a neural network, the neural network comprises a target detection network, a correction network and a recognition network, the target detection network is configured to perform a key point detection on the image to be processed, the correction network is configured to correct the target region, and the recognition network is configured to recognize the regional image information,
wherein the processor is further configured to invoke the processor executable instructions stored in the memory to:
train the target detection network according to a preset training set to obtain a trained target detection network, the training set comprising a plurality of sample images, and contour key point denoting information, background denoting information and category denoting information of a target region in each of the sample images; and
train the correction network and the recognition network according to the training set and the trained target detection network.

17. The apparatus according to claim 16, wherein the target detection network includes a feature extraction sub-network, a feature fusion sub-network and a detection sub-network, and
training the target detection network according to a preset training set to obtain a trained target detection network comprising:
performing a feature extraction on the sample images by the feature extraction sub-network to obtain first features of the sample images;
performing a feature fusion on the first features by the feature fusion sub-network to obtain a fused feature of the sample images;
detecting the fused feature by the detection sub-network to obtain contour key point detection information and background detection information of a target in the sample images; and
training the target detection network according to the contour key point detection information and background detection information for the plurality of sample images as well as the contour key point denoting information and the background denoting information for the plurality of sample images, to obtain the trained target detection network.

18. The apparatus according to claim 10, wherein the target region includes a license plate region of a vehicle, and the recognition result of the target region includes a character category of the license plate region.

19. A non-transitory computer readable storage medium having computer program instructions stored thereon, wherein the computer program instructions, when executed by a processor, cause the processor to:
perform a key point detection on an image to be processed to determine information of a plurality of contour key points of a target region in the image to be processed;
correct the target region in the image to be processed according to the information of the plurality of contour key points to obtain regional image information of a corrected region corresponding to the target region; and
recognize the regional image information to obtain a recognition result of the target region.

20. The non-transitory computer readable storage medium according to claim 19, wherein performing a key point detection on an image to be processed to determine information of a plurality of contour key points of a target region in the image to be processed includes:
performing a feature extraction and fusion on the image to be processed to obtain a feature map of the image to be processed; and
performing a key point detection on the feature map of the image to be processed to obtain the information of a plurality of contour key points of the target region in the image to be processed.
